(19) United States
(12) Patent Application Publication
(10) Pub. No.: US 2023/0145605 A1
(43) Pub. Date: May 11, 2023

(54) SPATIAL OPTIMIZATION FOR AUDIO PACKET TRANSFER IN A METAVERSE

(71) Applicants: Apurva Shah, San Mateo, CA (US); Roberto De Ioris, Rome (IT)

(72) Inventors: Apurva Shah, San Mateo, CA (US); Roberto De Ioris, Rome (IT)

(21) Appl. No.: 17/983,147

(22) Filed: Nov. 8, 2022

Related U.S. Application Data
(60) Provisional application No. 63/277,553, filed on Nov. 9, 2021.

(51) Int. Cl. H04L 65/75; G10L 21/0316

(52) U.S. Cl. CPC H04L 65/75; G10L 21/0316

(57) ABSTRACT

A computer-implemented method includes receiving audio packets associated with a first client device, where the audio packets each include an audio capture waveform, a timestamp, and a digital entity identification (ID). The method further includes determining, based on the digital entity ID, a position of a first digital entity in a metaverse. The method further includes determining a subset of other digital entities in a metaverse that are within an audio area of the first digital entity based on (a) a falloff distance between the first digital entity and each of the other digital entities and (b) a direction of audio propagation between the first digital entity and each of the other digital entities. The method further includes transmitting the audio packets to second client devices associated with the subset of other digital entities in the metaverse.

### CROSS REFERENCES TO RELATED APPLICATIONS

This application is related to U.S. Provisional Pat. Application Serial No. 63/277,553 entitled “Spatial Optimization for VoIP Packet Transfer in the Metaverse,” and filed Nov. 9, 2021, the entirety of which is incorporated by reference as if set forth in full in this application for all purposes.

### BACKGROUND

This description generally relates to spatial optimization for audio packet transfer in a metaverse, and more specifically to determining a subset of avatars in a metaverse that are within an audio area of a first avatar.

Distance is a nebulous concept in a metaverse. Sounds from one user (e.g., speech, clapping, hammering, etc.) at a location in the simulated world can immediately be sent to a second user regardless of their simulated distance apart. A computing device, such as a server, may transmit audio from anywhere in the metaverse to any user’s client device, but without controlled limitations, the user can become overwhelmed with audio from too many sources. Previous attempts to remedy the issue have included peer-to-peer audio communications on non-spatial channels outside of the experience, but this interferes with users having a realistic experience in the metaverse.

### SUMMARY

According to one aspect, a computer-implemented method includes receiving audio packets associated with a first client device, where the audio packets each include an audio capture waveform, a timestamp, and a digital entity identification (ID). The method further includes determining, based on the digital entity ID, a position of a first digital entity in a metaverse. The method further includes determining a subset of other digital entities in a metaverse that are within an audio area of the first digital entity based on (a) a falloff distance between the first digital entity and each of the other digital entities and (b) a direction of audio propagation between the first digital entities and each of the other digital entities. The method further includes transmitting the audio packets to second client devices associated with the subset of other digital entities in the metaverse.

In some embodiments, the falloff distance is a threshold distance and the subset of other digital entities are within the audio area if a distance between the first digital entities and the subset of other digital entities is less than the threshold distance. In some embodiments, determining that the subset of other digital entities in the metaverse that are within the audio area of the first digital entities is further based on whether an object occludes a path between the first digital entities and the other digital entities. In some embodiments, determining that the subset of other digital entities in the metaverse that are within the audio area of the first digital entities is further based on whether one or more objects in the metaverse cause wavelength specific absorption and reverberation of the audio packets. In some embodiments, determining that the subset of other digital entities in the metaverse that are within the audio area of the first digital entities is further based on whether the first digital entities is a cone of focus that corresponds to a visual focus of attention of each of subset of other digital entities. In some embodiments, determining that the subset of other digital entities in the metaverse that are within the audio area of the first digital entities is further based on whether the first digital entities and the subset of other digital entities are within a virtual audio bubble. In some embodiments, the audio packets are first audio packets and further comprising: mixing the audio packets with at least one selected from the group of second audio packets associated with the second client devices, environmental sounds in the metaverse, a music track, and combinations thereof to form an audio stream and the audio packets are transmitted as part of the audio stream. In some embodiments, the first digital entity is a first avatar, the other digital entities are other avatars, and determining that the subset of other avatars in the metaverse that are within the audio area of the first avatar is further based on determining a social affinity between the first avatar and the subset of other avatars. In some embodiments, the method further includes responsive to the audio capture waveform failing to meet an amplitude threshold or determining that the one or more of the audio packets are out of order based on the timestamp, discarding one or more corresponding audio packets. In some embodiments, the operations further include modifying an amplitude of the audio capture waveform based on one or more additional characteristics selected from the group of an environmental context, a technological context, a user actionable physical action, a user selection from a user interface, or combinations thereof. In some embodiments, the first digital entity is a first avatar or a virtual object that corresponds to a digital twin of a real-world object.

According to one aspect, a device includes a processor and a memory coupled to the processor, with instructions stored thereon that, when executed by the processor, cause the processor to perform operations comprising: generating a virtual object in a metaverse that is a digital twin of a real-world object, wherein the real-world object is a first client device, generating a simulation of the virtual object in the metaverse based on real or simulated sensor data from sensors associated with the real-world object, receiving audio packets associated with the real-world object, wherein the audio packets are real or simulated and each include an audio capture waveform, a timestamp, and a digital entity ID, determining, based on the digital entity ID, a position of the virtual object in the metaverse, determining a subset of digital entities in the metaverse that are within an audio area of the first avatar based on (a) a falloff distance between the virtual object and each of the digital entities and (b) a direction of audio propagation between the virtual object and each of the other digital entities, and transmitting the audio packets to client devices associated with the subset of other avatars in the metaverse.

In some embodiments, the sensors associated with the real-world object are selected from the group of an audio sensor, an image sensor, a hydrophone, an ultrasound device, light detection and ranging (LiDAR), a laser altimeter, a navigation sensor, an infrared sensor, a motion detector, and combinations thereof. In some embodiments, the falloff distance is a threshold distance and the subset of digital entities are within the audio area if a distance between the virtual object and the subset of digital entities is less than the threshold distance. In some embodiments, determining that the subset of digital entities in the metaverse that are within the audio area of the virtual object is further based on whether an object occludes a path between the virtual object and the other digital entities. metaversemetaverse

According to one aspect, non-transitory computer-readable medium with instructions stored thereon that, when executed by one or more computers, cause the one or more computers to perform operations, the operations comprising: receiving audio packets associated with a first client device, wherein the audio packets each include an audio capture waveform, a timestamp, and a digital entity ID, determining, based on the digital entity ID, a position of a first digital entity in a metaverse, determining a subset of other digital entities in a metaverse that are within an audio area of the first digital entity based on (a) a falloff distance between the first digital entity and each of the other digital entities and (b) a direction of audio propagation between the first digital entity and each of the other digital entities, and transmitting the audio packets to second client devices associated with the subset of other digital entities in the metaverse.

In some embodiments, the falloff distance is a threshold distance and the subset of other digital entities are within the audio area if a distance between the first digital entity and the subset of other digital entities is less than the threshold distance. In some embodiments, determining that the subset of other digital entities in the metaverse that are within the audio area of the first digital entity is further based on whether an object occludes a path between the first digital entity and the other digital entities. In some embodiments, determining that the subset of other digital entities in the metaverse that are within the audio area of the first digital entity is further based on whether one or more objects in the metaverse cause wavelength specific absorption and reverberation of the audio packets. In some embodiments, determining that the subset of other digital entities in the metaverse that are within the audio area of the first digital entity is further based on whether the first digital entity is a cone of focus that corresponds to a visual focus of attention of each of subset of other digital entities.

The technology described below advantageously simulates hearing distance for avatars within the metaverse to provide a seamless converse of real-world concepts to a virtual environment.

### BRIEF DESCRIPTION OF THE DRAWINGS

FIG. 1 is a block diagram of an example network environment to determine avatars within an audio area, according to some embodiments described herein.

FIG. 2 is a block diagram of an example computing device to determine avatars within an audio area, according to some embodiments described herein.

FIG. 3 is an example block diagram of an audio packet, according to some embodiments described herein.

FIG. 4A is an example block diagram of different avatars in a metaverse, according to some embodiments described herein.

FIG. 4B is an example block diagram of a cone of focus, according to some embodiments described herein.

FIG. 4C is an example block diagram of a virtual audio bubble, according to some embodiments described herein.

FIG. 4D is an example block diagram that illustrates ray tracing, according to some embodiments described herein.

FIG. 5 is an example block diagram of a social graph, according to some embodiments described herein.

FIG. 6 is an example block diagram of a spatial audio architecture, according to some embodiments described herein.

FIG. 7 is an example flow diagram of a method to determine a subset of digital entities that are within an audio area of a first digital entity, according to some embodiments described herein.

FIG. 8 is an example flow diagram of a method to determine a subset of digital entities that are within an audio area of a digital twin, according to some embodiments described herein.

### DETAILED DESCRIPTION

### Network Environment 100

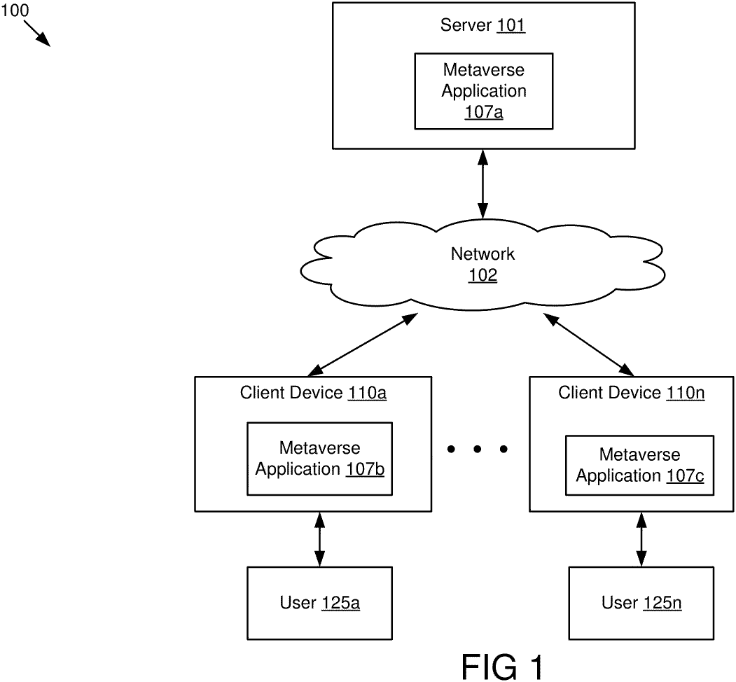

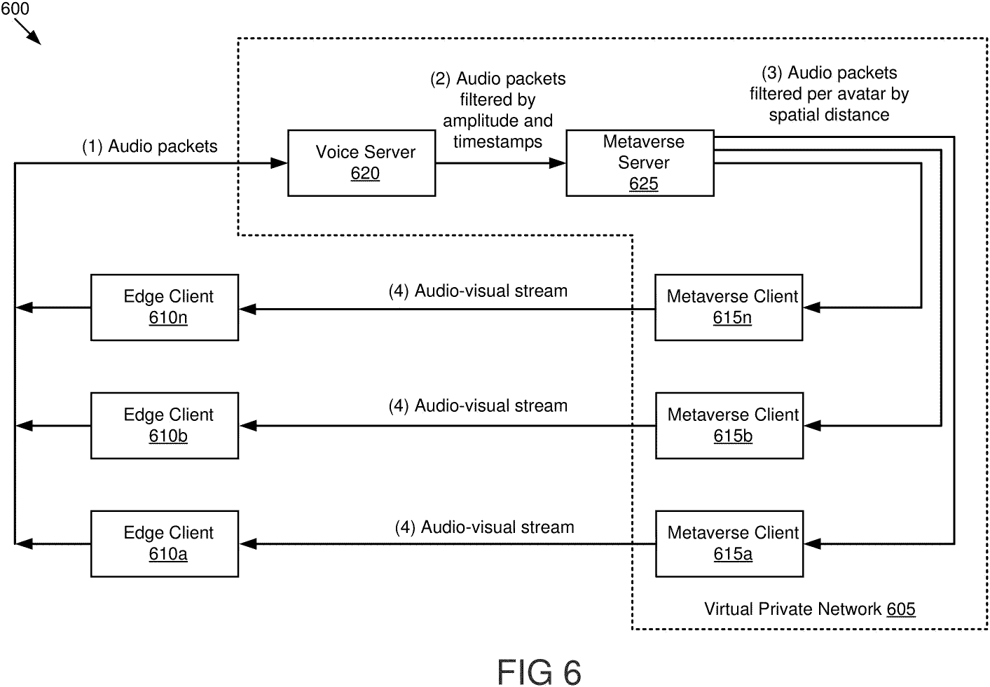

FIG. 1 illustrates a block diagram of an example environment 100 to determine a subset of avatars that are within an audio area. In some embodiments, the environment 100 includes a server 101, client devices 115a...n, and a network 102. Users 125a...n may be associated with the respective client devices 115a...n. In FIG. 1 and the remaining figures, a letter after a reference number, e.g., “107a,” represents a reference to the element having that particular reference number. A reference number in the text without a following letter, e.g., “107,” represents a general reference to embodiments of the element bearing that reference number. In some embodiments, the server 101 is a standalone server or is implemented within a single system, such as a cloud server, while in other embodiments, the server 101 is implemented within one or more computing systems, servers, data centers, etc., such as the voice server and the metaverse server illustrated in FIG. 6.

The server 101 includes one or more servers that each include a processor, a memory, and network communication hardware. In some embodiments, the server 101 is a hardware server. The server 101 is communicatively coupled to the network 102. In some embodiments, the server 101 sends and receives data to and from the client devices 115. The server 101 may include a metaverse application 107a.

In some embodiments, the server 101 receives audio packets from client devices 110. For example, the server 101 may receive an audio packet from the client device 110a associated with a first digital entity, such as an avatar or a virtual object, and determine whether a second digital entity associated with client device 110n is within an audio area of the first avatar. If the second digital entity is within the audio area of the first digital entity, the server 101 transmits the audio packet to the client device 110n.

The client device 110 may be a computing device that includes a memory, a hardware processor, and a microphone. For example, the client device 110 may include a mobile device, a tablet computer, a mobile telephone, a wearable device, a head-mounted display, a mobile email device, a portable game player, a portable music player, a teleoperated device (e.g., a robot, an autonomous vehicle, a submersible, etc.), or another electronic device capable of accessing a network 102.

Client device 110a includes metaverse application 107b and client device 110n includes metaverse application 107c. In some embodiments, the metaverse application 107b detects audio from the user 125a and generates an audio packet. In some embodiments, the audio packet is transmitted to the server 101 for processing or the processing occurs on the client device 110a. Once the audio packet has been approved for transmission, the metaverse application 107a on the server 101 transmits the communication to the metaverse application 107c on the client device 110n for the user 125n to hear.

In some embodiments, a metaverse application 107 receives audio packets associated with a first client device. The audio packets each include an audio capture waveform, a timestamp, and a digital entities identification (ID). If the audio capture waveform fails to meet an amplitude threshold, for example, because the audio is too low to be detectable and/or reliable, the metaverse application 107 discards one or more corresponding audio packets. In some embodiments, if any of the audio packets are out of order according to the timestamps, the metaverse application 107 discards the corresponding audio packets.

The metaverse application 107 determines a subset of other digital entities in a metaverse that are within an audio area of the first digital entity. The metaverse application 107 may determine the audio area based on a falloff distance between the first digital entity and each of the other digital entities. The metaverse application 107 may further determine the audio area based on a direction of audio propagation between the first digital entity and each of the other digital entities. For example, audio from a first avatar may not be within an audio area of a second avatar if the first avatar is facing away from the second avatar.

The metaverse application 107 transmits the audio packets to second client devices associated with the subset of other digital entities in the metaverse. In some embodiments, the audio packets are first audio packets and the metaverse application 107 mixes the first audio packets with second audio packets that are also determined to be within the audio area of the second client devices. In some embodiments, the metaverse application 107 performs the mixing on the server 101 or the client device 110n.

In the illustrated embodiment, the entities of the environment 100 are communicatively coupled via a network 102. The network 102 may include any combination of local area and/or wide area networks, using both wired and/or wireless communication systems. In one embodiment, the network 102 uses standard communications technologies and/or protocols. For example, the network 102 includes communication links using technologies such as Ethernet, 802.11, worldwide interoperability for microwave access (WiMAX), 3G, 4G, 5G, code division multiple access (CDMA), digital subscriber line (DSL), etc. Examples of networking protocols used for communicating via the network 102 include multiprotocol label switching (MPLS), transmission control protocol/Internet protocol (TCP/IP), hypertext transport protocol (HTTP), simple mail transfer protocol (SMTP), file transfer protocol (FTP), and User Datagram Protocol (UDP). Data exchanged over the network 102 may be represented using any suitable format, such as hypertext markup language (HTML) or extensible markup language (XML). In some embodiments, all or some of the communication links of the network 102 may be encrypted using any suitable techniques.

### Computing Device Example 200

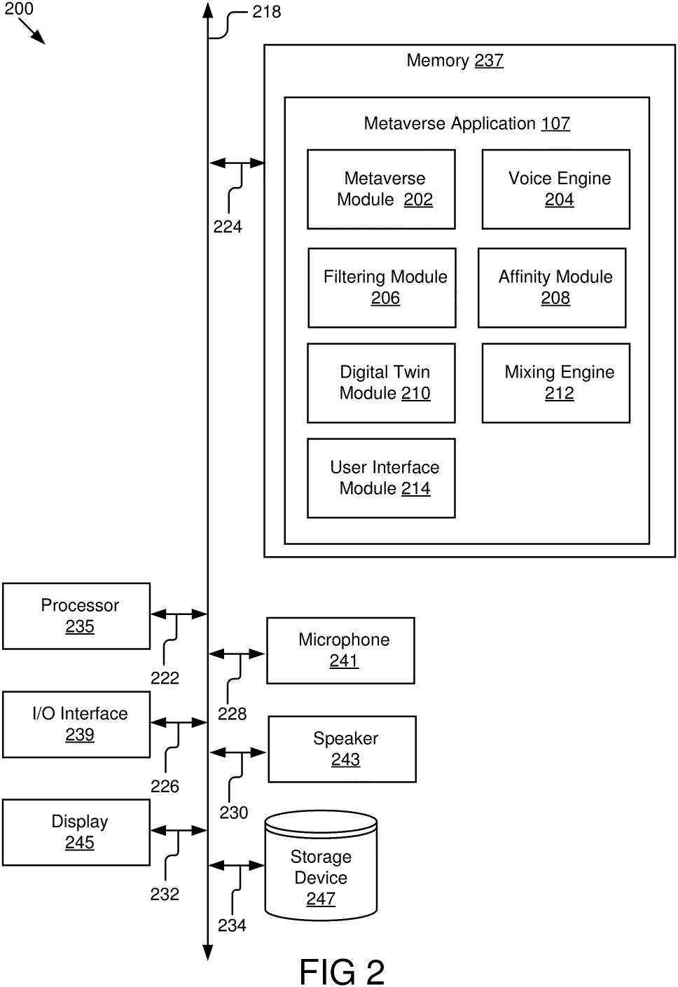

FIG. 2 is a block diagram of an example computing device 200 that may be used to implement one or more features described herein. Computing device 200 can be any suitable computer system, server, or other electronic or hardware device. In some embodiments, computing device 200 is the server 101. In some embodiments, the computing device 200 is the client device 110.

In some embodiments, computing device 200 includes a processor 235, a memory 237, an Input/Output (I/O) interface 239, a microphone 241, a speaker 243, a display 245, and a storage device 247. Depending on whether the computing device 200 is the server 101 or the client device 110, some components of the computing device 200 may not be present. For example, in instances where the computing device 200 is the server 101, the computing device may not include the microphone 241, the speaker 243, and the display 245. In some embodiments, the computing device 200 includes additional components not illustrated in FIG. 2.

The processor 235 may be coupled to a bus 218 via signal line 222, the memory 237 may be coupled to the bus 218 via signal line 224, the I/O interface 239 may be coupled to the bus 218 via signal line 226, the microphone 241 may be coupled to the bus 218 via signal line 228, the speaker 243 may be coupled to the bus 218 via signal line 230, the display 245 may be coupled to the bus 218 via signal line 232, and the storage device 247 may be coupled to the bus 218 via signal line 234.

The processor 235 includes an arithmetic logic unit, a microprocessor, a general-purpose controller, or some other processor array to perform computations and provide instructions to a display device. Although FIG. 2 illustrates a single processor 235, multiple processors 235 may be included. In different embodiments, processor 235 may be a single-core processor or a multicore processor. Other processors (e.g., graphics processing units), operating systems, sensors, displays, and/or physical configurations may be part of the computing device 200.

The memory 237 stores instructions that may be executed by the processor 235 and/or data. The instructions may include code and/or routines for performing the techniques described herein. The memory 237 may be a dynamic random access memory (DRAM) device, a static RAM, or some other memory device. In some embodiments, the memory 237 also includes a non-volatile memory, such as a static random access memory (SRAM) device or flash memory, or similar permanent storage device and media including a hard disk drive, a compact disc read only memory (CD-ROM) device, a DVD-ROM device, a DVD-RAM device, a DVD-RW device, a flash memory device, or some other mass storage device for storing information on a more permanent basis. The memory 237 includes code and routines operable to execute the metaverse application 107, which is described in greater detail below.

I/O interface 239 can provide functions to enable interfacing the computing device 200 with other systems and devices. Interfaced devices can be included as part of the computing device 200 or can be separate and communicate with the computing device 200. For example, network communication devices, storage devices (e.g., memory 237 and/or storage device 247), and input/output devices can communicate via I/O interface 239. In another example, the I/O interface 239 can receive data from the server 101 and deliver the data to the metaverse engine 107 and components of the metaverse engine 107. In some embodiments, the I/O interface 239 can connect to interface devices such as input devices (keyboard, microphone 241, sensors, etc.) and/or output devices (display 245, speaker 243, etc.). In some embodiments, the input devices used in conjunction with the metaverse application 107 include motion tracking headgear and controllers, cameras that track body movements and facial expressions, hand-held controllers, augmented or virtual-reality goggle or other equipment. In general, any suitable types of peripherals can be used.

Some examples of interfaced devices that can connect to I/O interface 239 can include a display 245 that can be used to display content, e.g., images, video, and/or a user interface of an output application as described herein, and to receive touch (or gesture) input from a user. Display 245 can include any suitable display device such as a liquid crystal display (LCD), light emitting diode (LED), or plasma display screen, cathode ray tube (CRT), television, monitor, touchscreen, three-dimensional display screen, or other visual display device.

The microphone 241 includes hardware for detecting audio spoken by a person. The microphone 241 may transmit the audio to the metaverse engine 107 via the I/O interface 239.

The speaker 243 includes hardware for generating audio for playback. For example, the speaker 243 receives instructions from the metaverse engine 107 to generate audio from audio packets. The speaker 233 converts the instructions to audio and generates audio for the user.

The storage device 247 stores data related to the metaverse application 107. The storage device 247 may be a non-transitory computer readable memory. The storage device 247 may store data associated with the metaverse engine 107, such as properties, characteristics, appearance, and logic representative of and governing objects in a metaverse (such as people, animals, inanimate objects, buildings, vehicles, etc.) and materials (such as surfaces, ground materials etc.) for use in generating the metaverse. Accordingly, when the metaverse application 107 generates a metaverse, an object selected for inclusion in the metaverse (such as a wall) can be accessed from the storage device 247 and included within the metaverse, and all the properties, characteristics, appearance, and logic for the selected object can succinctly be instantiated in conjunction with the selected object. In some embodiments, the storage device 247 further includes social graphs that include relationships between different users 125 in the metaverse and profiles for each user 125 associated with an avatar, etc.

### Example Metaverse Engine 107

FIG. 2 illustrates a computing device 200 that executes an example metaverse application 107 that includes a metaverse module 202, a voice engine 204, a filtering module 206, an affinity module 208, a digital twin module 210, a mixing engine 212, and a user interface module 214. Although the components of the metaverse application 107 are illustrated as being part of the same metaverse application 107, persons of ordinary skill in the art will recognize that the components may be implemented by different computing devices 200. For example, the metaverse module 202, the voice engine 204, and the filtering module 206 may be part of the server 101 and the mixing engine 212 may be part of a client device 110. In another example, the voice engine 204 may be part of a first client device 110, the metaverse module 202 and the filtering module 206 may be part of the server 101, and the mixing engine 212 may be part of a second client device 110.

The metaverse module 202 generates a metaverse for a user. In some embodiments, the metaverse module 202 includes a set of instructions executable by the processor 235 to generate the metaverse. In some embodiments, the metaverse module 202 is stored in the memory 237 of the computing device 200 and can be accessible and executable by the processor 235.

The metaverse module 202 instantiates and generates a metaverse in which user behavior can be simulated and displayed through the actions of avatars. As used herein, “metaverse” refers to a computer-rendered representation of reality. The metaverse includes computer graphics representing objects and materials within the metaverse and includes a set of property and interaction rules that govern characteristics of the objects within the metaverse and interactions between the objects. In some embodiments, the metaverse is a realistic (e.g., photo-realistic, spatial-realistic, sensor-realistic, etc.) representation of a real-world location, enabling a user to simulate the structure and behavior of an avatar in the metaverse.

In some embodiments, the metaverse includes digital entities. The digital entities may be avatars that correspond to human users or virtual objects that are digital twins of real-world objects. An avatar represents an electronic image that is manipulated by the user within the metaverse. The avatar may be any representation chosen by a user. For example, the avatar may be a graphical representation of a user that is generated from an image of the user is converted into the avatar. In another example, the avatar may be selected from a set of options presented to the user via a user interface generated by the user interface module 214. The avatar may resemble a human, an animal, a fanciful representation of a creature, a robot, a drone, etc. Each avatar is associated with a digital entities identification (ID), which is a unique ID that is used to track the digital entity in the metaverse.

In some embodiments, metaverse module 202 tracks a position of each object within the metaverse. For example, the metaverse may be defined as a three-dimensional world with x, y, and z coordinates where z is indicative of altitude. For example, the metaverse module 202 may generate a metaverse that includes drones and the position of the drones includes their altitude during flights. In some embodiments, the metaverse module 202 associates the digital entity ID with a position of the avatar in the metaverse.

The metaverse module 202 may include a graphics engine configured to generate three-dimensional graphical data for displaying the metaverse. The graphics engine can, using one or more graphics processing units, generate the three-dimensional graphics depicting the metaverse, using techniques including three-dimensional structure generation, surface rendering, shading, ray tracing, ray casting, texture mapping, bump mapping, lighting, rasterization, etc. In some embodiments, the graphics engine can, using one or more processing units, generate representations of other aspects of the metaverse, such as audio waves within the metaverse. For example, the audio waves may be transmitted in the open air when the avatars are on a surface of the earth (e.g., the audio includes the sound of reads on gravel), underwater where the metaverse includes submersibles, such as submarines, and the metaverse module 202 represents how audio travels through different mediums with different sensors, such as hydrophones, sonar sensors, ultrasonic sensors, etc.

The metaverse module 202 may include a physics engine configured to generate and implement a set of property and interaction rules within the metaverse. In practice, the physics engine implements a set of property and interaction rules that mimic reality. The set of property rules can describe one or more physical characteristics of objects within the metaverse, such as characteristics of materials the objects are made of (e.g., weight, mass, rigidity, malleability, flexibility, temperature, etc.). Likewise, the set of interaction rules can describe how one or more objects interact (for instance, describing how an object moves in the air, on land or underwater; describing a relative motion of a first object to a second object; a coupling between object; friction between surfaces of objects, etc.). In some embodiments, the physics engine implements rules about the position of objects, such as maintaining consistency in distances between the users. The physics engine can simulate rigid body dynamics, collision detection, soft body dynamics, fluid dynamics, particle dynamics, etc.

The metaverse module 202 may include sound engines to produce audio representative of the metaverse (such as audio representative of objects within the metaverse, representative of interactions between objects within the metaverse, and representative of ambient or background noise within the metaverse). Likewise, the metaverse module 202 can include one or more logic engines that implement rules governing a behavior of objects within the metaverse (such as a behavior of people, animals, vehicles, or other objects generated within the metaverse that are controlled by the metaverse module 202 and that aren’t controlled by users).

The metaverse module 202 generates a metaverse that may include one or more ground surfaces, materials, or substances (such as gravel, dirt, concrete, asphalt, grass, sand, water, etc.). The ground surfaces can include roads, paths, sidewalks, beaches, etc. The metaverse can also include buildings, houses, stores, restaurants, and other structures. In addition, the metaverse module 202 can include plant life, such as trees, bushes, vines, flowers, etc. The metaverse can include various objects, such as benches, stop signs, crosswalks, rocks, and any other object found in real life. The metaverse can include representations of particular location types, such as city blocks in dense urban sprawls, residential neighborhoods in suburban locations, farmland and forest in rural areas, construction sites, lakes and rivers, bridges, tunnels, playgrounds, parks, etc. In addition to identifying types of objects within the metaverse, a user may specify a location within the metaverse at which the various objects within the metaverse are located. In addition, the metaverse can include representations of various weather conditions, temperature conditions, atmospheric conditions, etc., each of which can, in an approximation of reality, affect the movement and behavior of avatars.

In some embodiments, the voice engine 204 receives audio packets associated with a client device. In some embodiments, the voice engine 204 includes a set of instructions executable by the processor 235 to receive audio packets associated with a client device. In some embodiments, the voice engine 204 is stored in the memory 237 of the computing device 200 and can be accessible and executable by the processor 235.

After the metaverse module 202 generates a metaverse with an avatar corresponding to a user, the user provides audio to a microphone associated with the client device. For example, the user may be speaking to another avatar in the metaverse. The voice engine 204 receives audio packets of the audio captured by the microphone associated with the client device. The audio packets include an audio capture waveform that corresponds to a compressed version of the audio provided by the user, a timestamp, and a digital entity ID corresponding to a digital entity in the metaverse. In some embodiments, the timestamp includes milliseconds.

In some embodiments, the digital twin module 210 generates a simulation and the audio packets include simulated audio packets.

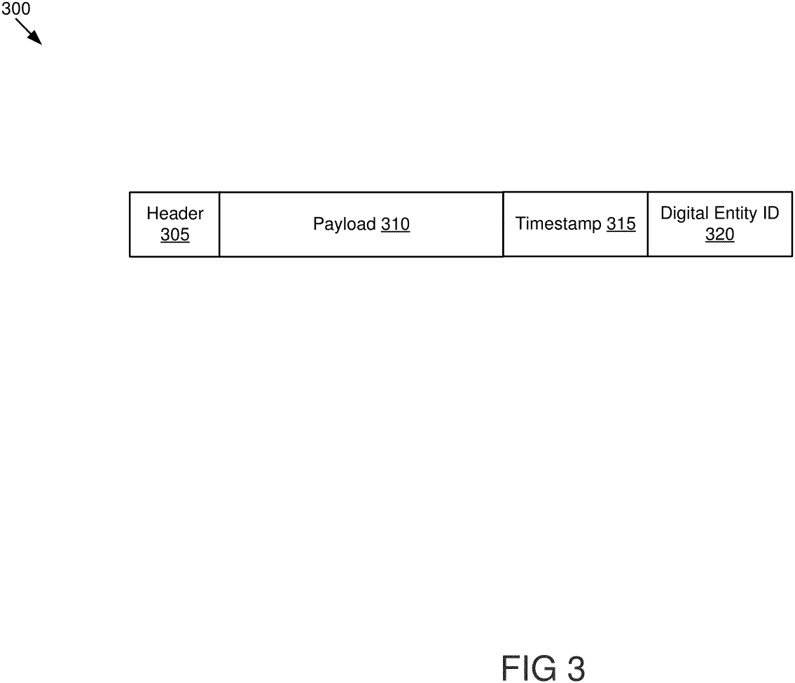

Turning to FIG. 3, a block diagram of an audio packet 300 is illustrated. In this example, the audio packet 300 includes a header 305, a payload 310, a timestamp 315, and an digital entity ID 320. The header 305 includes information for routing the audio packet 300. For example, the header 305 may include an internet protocol (IP) header and a user datagram protocol (UDP) header, which are used to route the packet to the appropriate destination. The payload 310 is the audio capture waveform that corresponds to the audio provided by the user.

In some embodiments, the voice engine 204 is stored on the client device and receive the audio packets from the microphone 241 via the I/O interface 239. In some embodiments, the voice engine 204 is stored on the server 101 and receive the audio packets from the client device over a standard network protocol, such as transmission control protocol protocol/internet protocol (TCP/IP).

The voice engine 204 determines whether the audio capture waveform meets an amplitude threshold. Responsive to the audio capture waveform failing to meet the amplitude threshold, the voice engine 204 discards one or more corresponding audio packets. For example, if the user is speaking and some of the audio falls below the amplitude threshold, the audio may be so quiet that the information is not reliably captured.

In some embodiments, the voice engine 204 determines whether any of the audio packets are out of order. Specifically, the voice engine 204 identifies each of the audio packets based on the timestamp and if any of the timestamps are out-of-order, the voice engine 204 discards those packets. Discarding out-of-order audio packets avoids receiving broken-sounding audio because the out-of-order audio packet cannot be resequenced back into an audio stream after the next audio packet has already been transmitted to the client device.

The voice engine 204 transmits the audio packets that meet the amplitude threshold and/or the audio packets that are in order to the filtering module 206.

The filtering module 206 determines a subset of avatars within the metaverse that are within an audio area of a first avatar. In some embodiments, the filtering module 206 includes a set of instructions executable by the processor 235 to determine the subset of avatars that are within an audio area of the first avatar. In some embodiments, the filtering module 206 is stored in the memory 237 of the computing device 200 and can be accessible and executable by the processor 235.

The filtering module 206 filters audio packets per avatar based on whether the avatars are within an audio area of a first avatar. The filtering module 206 determines, based on a digital entity ID associated with a first avatar, a position of the first avatar in the metaverse. For example, the filtering module 206 queries the metaverse module 202 to provide the position of the first avatar and the filtering module 206 receives particular (x, y, z) coordinates in the metaverse where the z-coordinates correspond to the altitude of the avatar. In some embodiments, the filtering module 206 also determines a direction of audio propagation by the first user.

The filtering module 206 determines a subset of other avatars in the metaverse that are within an audio area of the first avatar based on a falloff distance between the first avatar and each of the other avatars. For example, the falloff distance may be a threshold distance after which a voice amplitude falls below an audible level. In another example, the falloff distance may include parameters in a curve (linear, exponential, etc.) and attenuate before cutting off. In some embodiments, the falloff distance corresponds to how volume is perceived in the real world. For example, the human ear can hear sounds starting at 0 decibels (dB) to about 130 db (without experiencing pain) and the intelligible outdoor range of the male human voice in still air is 590 feet (180 meters). But because 590 feet is the farthest distance in optimal conditions, the falloff distance may be less than 590 feet. For example, the falloff distance may be 10 feet if considered independent of the direction of the avatars. In some embodiments, the falloff distance is defined by a designer of the particular metaverse.

In one example, a first avatar is a security robot that receives audio packets from other avatars that correspond to client devices in a room. The information that is detected by the security robot and the client devices are converted into data that is displayed in a metaverse for an administrator to view. Instead of using a security robot that has multiple expensive image sensors, the robot includes many microphones that are designed to pickup audio around the room. In some embodiments, the administrator uses the metaverse to provide instructions to the security robot to inspect the sources of audio to determine if they are a security risk.

In some embodiments, the filtering module 206 determines the falloff distance based on the amplitude of the audio wave in the audio packet. For example, the filtering module 206 may determine that the audio packets associated with a first avatar correspond to a user that is yelling. As a result, the falloff distance is greater than if the user is speaking at a normal volume.

In some embodiments, the filtering module 206 modifies an amplitude of the audio capture waveform, clarity of the audio, effects of the audio, etc., based on one or more additional characteristics that include one or more of an environmental context, a technological context, a user actionable physical action, and/or a user selection from a user interface. The environmental context may include events that occur underwater, in a vacuum, humidity of simulated air, etc. The technological context may include objects that an avatar interacts with, such as a megaphone, intercom, broadcast, hearing air, listening device, etc. The user actionable physical action may include listening harder as evidenced by the user cocking their head in a particular direction, cupping their hand to their ear, a user raising or lowering their voice, etc. In some embodiments, the microphone 241 detects the user raising or lowering their voice prior to implementing automatic gain control or is a value obtained from the automatic gain control setting. The user selection from a user interface may include prioritizing users such as friends, defined groups, a maximum number of sources at a time, an emergency alert mode from a sender, etc.

In some embodiments, the filtering module 206 determines a subset of other avatars in the metaverse that are within an audio area of the first avatar based on a direction of audio propagation between the first avatar and the other avatars. For example, if the first avatar is facing away from a second avatar, the second avatar may not hear the audio unless the first avatar is very close to the second avatar. In some embodiments, the filtering module 206 calculates a vector between each of the first avatar and other avatars to determine the direction of sound wave propagation.

In some embodiments, the filtering module 206 determines a subset of avatars in the metaverse that are within an audio area of the first avatar based on whether an object occludes a path between the first avatar and the other avatars. For example, even if the first avatar and a second avatar are separated by a distance that is less than the falloff distance, audio waves will not transmit through certain objects, such as a wall.

In some embodiments, the filtering module 206 determines a subset of avatars in the metaverse that are within an audio area of the first avatar based on whether one or more objects in the metaverse cause wavelength specific absorption and reverberation of the audio packets. For example, the first user may speak next to a sound-reflective surface, such as a concert hall, that amplifies the audio produced by the first avatar. As a result, wavelength specific absorption and reverberation may extend the audio area beyond the falloff distance.

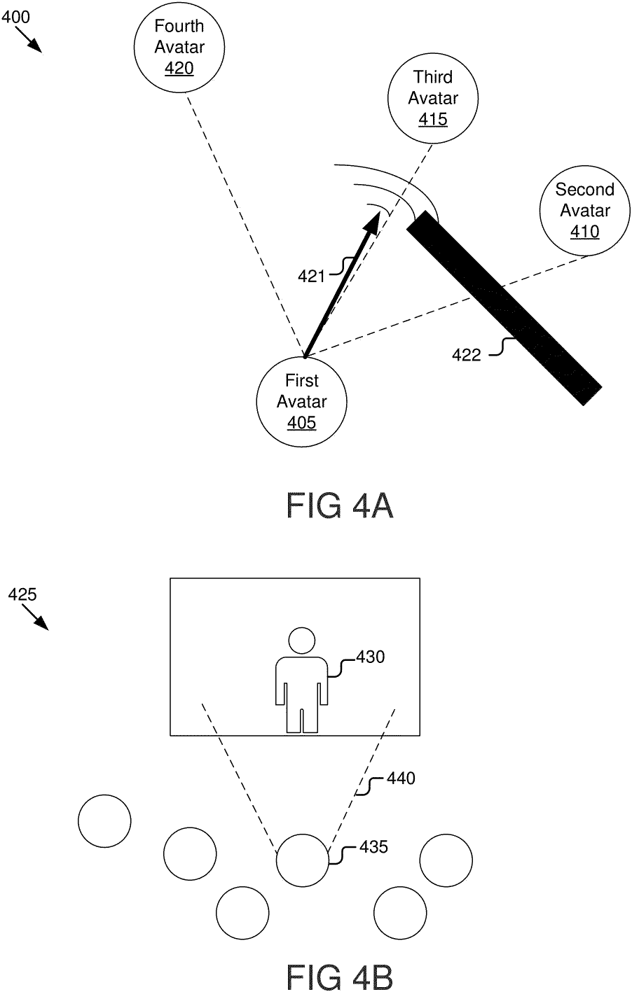

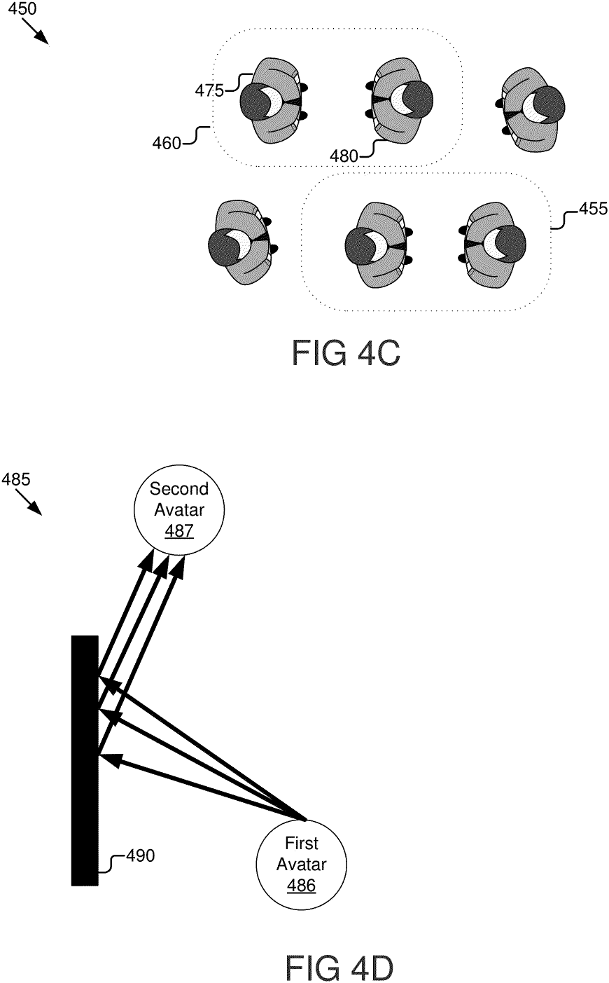

Turning to FIG. 4A, an example block diagram 400 of different avatars in a metaverse. In this example, there is a first avatar 405, a second avatar 410, a third avatar 415, and a fourth avatar 420. The direction of the first avatar 405 is illustrated with vector 421. In this example, the second avatar 410 is not within the audio area of the first avatar 405 because a wall 422 serves as an occluding object between the first avatar 405 and the second avatar 410. As a result, the audio packet associated with the first avatar 405 are not delivered to the client device associated with the second avatar 410.

The third avatar 415 is within the audio area of the first avatar 405 because the third avatar 415 is within the falloff distance and the first avatar 405 is facing the direction of the third avatar 415 as evidenced by the vector 421.

The fourth avatar 420 is not within the audio area of the first avatar 405 because the fourth avatar 420 is outside the falloff distance and because the first avatar 405 is facing a different direction than the fourth avatar 420 as evidenced by the vector 421.

In some embodiments, the filtering module 206 determines a subset of avatars in the metaverse that are within an audio area of the first avatar based on whether first avatar is within a cone of focus that corresponds to a visual focus of attention of each of the other avatars. The filtering module 206 applies the cone of focus to advantageously reduce crosstalk from avatars that are behind the listener or outside of the avatar’s visual focus.

FIG. 4B is an example block diagram 425 of a cone of focus, according to some embodiments described herein. In this example, the first avatar 430 is performing at a concert and the second avatar 435 is listening to the concert. The second avatar 435 is associated with a cone of focus 440 that encompasses the first avatar 430. In this example, the filtering module 206 transmits the audio packets generated by the first avatar 430 to the second avatar 435 and excludes audio packets generated by the other avatars, such as the other avatars sitting next to and behind the second avatar 435.

In some embodiments, the filtering module 206 determines a subset of avatars in the metaverse that are within an audio area of the first avatar based on whether first avatar and the subset of other avatars are within a virtual audio bubble. The virtual audio bubble may apply when the metaverse includes a crowded situation where two avatars are speaking with each other. For example, continuing with the example in FIG. 4B, if two of the audience members turn to each other during the concert, the filtering module 206 may determine that there is a virtual audio bubble surrounding the two avatars because they are facing each other and are sitting next to each other.

FIG. 4C is an example block diagram 450 of a virtual audio bubble. In this example, the block diagram 450 is a birds-eye view of avatars in a busy area, such as a business networking event where the avatars are all speaking in a conference room. In this example, even though the conference room includes six avatars, only audio packets within the first virtual audio bubble 455 and the second virtual audio bubble 460 are delivered to the opposing avatar within the bubble. In some embodiments, the filtering module 206 applies a virtual audio bubble to conversations between avatars when a threshold number of avatars are within proximity to a first user. For example, continuing with the example in FIG. 4C, the filtering module 206 may determine that when more than four avatars are within an audio area of a first avatar 475, the filtering module 206 applies the virtual audio bubble such that only the second avatar 480 is within the second virtual audio bubble 460.

In some embodiments, the filtering module 206 applies ray tracing to determine whether the first avatar is within an audio area of another avatar. The following example of ray tracing is merely one example and other examples are possible.

Ray tracing may include the filtering module 206 calculating ray launch directions for audio that is emitted by the first avatar. In some embodiments, the filtering module 206 calculates rays as being distributed from the location of the first avatar based on the direction of the first avatar. Each ray may be calculated as having an equal quantity of energy (e.g., determining that the first avatar is speaking at 60 dBs) and how the audio dissipates as a function of distance.

The filtering module 206 simulates the intersection of the ray with an object in the metaverse by using a triangle to represent the object. The triangle is chosen because it is a better primitive object for simulating complex interactions than, for example, a sphere. The filtering module 206 determines how the intersection of the ray with objects changes the direction of the audio. In some embodiments, the filtering module 206 calculates a new ray direction using a vector, such as the vector-based scattering method. The filtering module 206 generates a uniformly random vector within a hemisphere oriented in the same direction as the triangle normal. The filtering module may calculate an ideal specular direction where the two vectors are combined using equation 1: [0080]

$${{\to }_{R}}_{\text{outgoing}} \text{=} s {{\to }_{R}}_{\text{random}} + \left(1 - s\right) {{\to }_{R}}_{\text{specular}}$$

where s is the scatting coefficient, _̅{̅R̅}̅outgoing is the ray direction for the new ray, _̅{̅R̅}̅random is the ray that was randomly generated, and _̅{̅R̅}̅specular is the ray for the ideal specular direction.

The filtering module 206 determines if there is an energy loss because the object absorbs the audio or if the object amplifies the audio based on absorption coefficients (α)that correspond to the material of the object. For example, a forest may absorb the audio and a brick wall may amplify the audio.

The filtering module 206 determines the maximum required ray tracing depth, which is the location of where the energy of the audio falls below a detectible threshold. The filtering module 206 determines whether another avatar is within the audible area based on the maximum required ray tracing depth.

In some embodiments, the filtering module 206 determines the maximum ray tracing depth by determining a minimum absorption of all surfaces in the metaverse. The outgoing energy from a single reflection is equal to E_{incoming} (1 - α) where E_{incoming} is the incoming energy and α is the surface absorption. The outgoing energy from a series of reflections is given by E_{incoming} (1 - αₘᵢₙ)^{n_reflections}. The maximum ray tracing depth is equal to the number of reflections from the minimally absorptive surface required to reduce the energy of a ray by 60 dB, which is defined in equation 2: [0085]

$${\left(1 - {\text{α}}_{\text{min}}\right)}^{\text{n\_reflections}} = {10}^{\text{-6}} ∴ \text{n\_reflections =} \left⌈- \frac{6}{l o {g}_{10} \left(1 - {\text{α}}_{\text{min}}\right)}\right⌉$$

FIG. 4D is an example block diagram 485 that illustrates ray tracing. In this example, multiple rays are emitted from the direction of the first avatar 486 while the first avatar 486 is speaking. The rays intersect with an object 490. The rays are reflected from the object 490 to the second avatar 487. The filtering module 206 determines whether the audio reaches the second avatar 487 in part based on the absorptive characteristics of the object 490.

In some embodiments, the filtering module 206 determines a subset of avatars in the metaverse that are within an audio area of the first avatar based on a social affinity between the first avatar and the subset of other avatars. The filtering module 206 may receive an affinity value for each relationship between the first avatar and each of the other avatars from the affinity module 208. In some embodiments, the filtering module 206 applies a threshold affinity value to interactions. For example, if the first avatar is speaking within a falloff distance to a second avatar and a third avatar, but only the affinity value between the first avatar and the second avatar exceeds the threshold affinity value, the filtering module 206 transmits the audio packet to the client device associated with the second avatar and not the third avatar. In some embodiments, the filtering module 206 transmits the audio packets to any avatar that is within the falloff distance if the avatar is receiving audio packets from the first avatar and no other avatars, but if multiple avatars are within an audio area of a second avatar, the filtering module 206 transmits audio packets for one avatar from the multiple avatars with the highest social affinity.

In some embodiments, the filtering module 206 includes a machine-learning model that receives audio packets associated with a first avatar as input and outputs a determination of a subset of avatars that are to receive the audio packets. In some embodiments, the machine-learning model is trained with supervised learning based on training data that includes audio packets with different parameters and determinations about the subset of avatars that receive the audio packets. In some embodiments, the machine-learning model includes a neural network with multiple layers that becoming increasingly abstract in characterizing the parameters associated with different avatars and how that results in subsets of avatars being determined to be within the audio area.

Responsive to determining that the subset of other avatars are within the audio area of the first avatar, the filtering module 206 transmits the audio packets to the client devices associated with the other avatars. In some embodiments, the filtering module 206 transmits the audio packets to a mixing engine 212 for mixing the audio packets with other audio packets, ambient sounds, etc.

The affinity module 208 determines social affinities between users associated with the metaverse. In some embodiments, the affinity module 208 includes a set of instructions executable by the processor 235 to determine social affinities between users. In some embodiments, the affinity module 208 is stored in the memory 237 of the computing device 200 and can be accessible and executable by the processor 235.

In some embodiments, the affinity module 208 determines social affinities between users in the metaverse. For example, in some embodiments users may be able to define different relationships between users, such as friendships, business relationships, romantic relationships, enemies, etc. In some embodiments the relationships may be one sided where a first user follows a second user in the metaverse or two-sided where both users are described by the same relationship, such as when both users are friends with each other.

In some embodiments, the affinity module 208 determines weights that reflect an extent of the affinity between different users. For example, the affinity module 208 may determine that the relationship between users becomes stronger based on a number of interactions between users.

In some embodiments, the affinity module 208 the social affinities are based on degrees of separation between the users. For example, the affinity module 208 may determine that a first user that is friends with a second user that is friends with a third user has a second-degree relationship with third user.

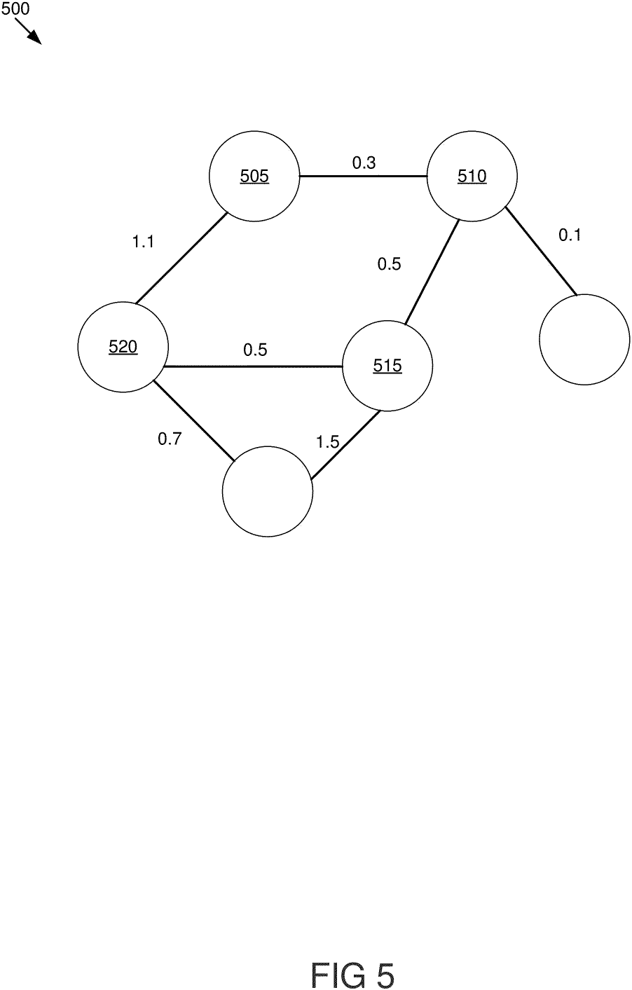

FIG. 5 is an example block diagram 500 of a social graph. The nodes in the social graph represent different users. The lines between the nodes in the social graph represent the social affinity between the users. The affinity module 208 determines different social affinities for the users 505, 510, 515, 520 based on different parameters, such as explicit relationships between the users, frequency of communications between the users, number of minutes that the users have played the same games together, etc. For example, user 505 has a social affinity of 0.3 with user 510 and a social affinity of 1.1 with user 520. In this example, a higher weight social affinity is associated with a stronger connection, but a different weighting scheme is also possible. User 510 has a social affinity of 0.5 with user 515. User 515 has a social affinity of 0.5 with user 520. Although the numbers here range from 0.1 to 1.5, persons of ordinary skill in the art will recognize that a variety of numbering schemes are possible here.

The digital twin module 210 generates a digital twin of a real-world object for the metaverse. In some embodiments, the digital twin module 210 includes a set of instructions executable by the processor 235 to generate the digital twin. In some embodiments, the digital twin module 210 is stored in the memory 237 of the computing device 200 and can be accessible and executable by the processor 235.

In some embodiments, the digital twin module 210 receives real sensor data or simulated sensor data about real-world objects and generates a virtual object that simulates the real-world object for the metaverse. For example, the real-world objects may include drones, robots, autonomous vehicles, unmanned aerial vehicles (UAVs), submersibles, etc. The data about the real-world agents includes any real or simulated sensor data that describes the real-world object as well as the environment. The sensors may include audio sensors (e.g., including sensors that detect audio frequencies that are undetectable to a human ear), image sensors (e.g., a Red Blue Green (RBG) sensor), hydrophones, ultrasound devices, light detection and ranging (LiDAR), a laser altimeter, a navigation sensor, an infrared sensor, a motion detector, a thermostat, a mass air flow sensor, a blind-spot meter, a curb feeler, a torque sensor, a turbine speed sensor, a variable reluctance sensor, a vehicle speed sensor, a water sensor, a wheel speed sensor, etc. The sensors may be on the real-world object and/or strategically placed in the environment. As a result, the audio packets associated with the real-world object may be real or simulated audio packets.

The digital twin module 210 receives or simulates the sensor data and generates a virtual object that digitally replicates the environment of the real-world object in the metaverse. In some embodiments, the digital twin module 210 uses the simulation to design a virtual object to test different parameters. In some embodiments, the simulation of the virtual object in the metaverse is based on real or simulated sensor data.

In a first example, the real-world object is a drone and the digital twin module 210 simulates noise levels generated by the drone while the drone moves around an environment. The digital twin module 210 generates a simulation based on the environment where the changed parameter is the number of drones and the simulation is used to test the noise levels of the drone for a study on the impact on sound pollution levels as a function of the number of drones. This may be very useful for urban planning development where generating sounds over a noise threshold results in bothering people that live in the same area as the drones

In a second example, the real-world objects are airplanes and the simulation includes an environment of the airplanes. The digital twin module 210 generates a simulation of air traffic in the metaverse that includes different levels of noise created by airplanes taking off and landing.

In a third example, the real-world object is a security robot that moves within an environment, such as a house or an office building. The simulation of the robot is used to test a security scenario that analyzes whether the robot can distinguish between human noises and machine noises in the metaverse. The simulation of the robot is used to modify features of the robot to better detect noises, such as by testing out different audio sensors or combinations of audio sensors and image sensors.

In a fourth example, the real-world object is an autonomous submersible, such as a submarine. The digital twin module 210 simulates virtual objects that simulate the autonomous submersibles in the metaverse. The digital twin module 210 generates a simulate that mimics sound waveforms and determines how sound travels through water based on real or simulated sensor data gathered from the real-world object.

The mixing engine 212 mixes audio packets with other audio to generate an audio stream. In some embodiments, the mixing engine 212 includes a set of instructions executable by the processor 235 to generate an audio stream. In some embodiments, the mixing engine 212 is stored in the memory 237 of the computing device 200 and can be accessible and executable by the processor 235.

In some embodiments, the mixing engine 212 is part of the server 101 illustrated in FIG. 1 for faster generation of the audio stream. In some embodiments, the mixing engine 212 is part of the client device 110.

In some embodiments, the mixing engine 212 mixes first audio packets with other audio sources to form an audio stream. For example, the mixing engine 212 may mix first audio packets from a first avatar with second audio packets from a second avatar into an audio stream that is transmitted to a third avatar that is within audio areas of both the first avatar and the second avatar. In another example, the mixing engine 212 mixes first audio packets with environmental sounds in the metaverse, such as an ambulance that is within an audio area of an avatar. In some embodiments, the mixing engine 212 incorporates information about the velocity of the ambulance while the ambulance moves to incorporate the increasing intensity of the noise and the ambulance gets closer to the avatar and then the decreasing intensity of the ambulance as the ambulance moves farther away from the avatar. In some embodiments, the mixing engine 212 mixes first audio packets with a music track to form the audio stream. Different variations are also possible, such as first audio packets, second audio packets, and a music track or first audio packets, environmental noises, and a music track.

In some embodiments, the mixing engine 212 generates an audio-visual stream that combines the audio stream with visual information for the metaverse. For example, the audio stream is synchronized to actions that occur within the metaverse, such as audio that corresponds to an avatar moving their mouth while speaking or a drone moving by an avatar while the audio stream includes the sound produced by the drone.

The user interface module 214 generates a user interface. In some embodiments, the user interface module 214 includes a set of instructions executable by the processor 235 to generate the user interface. In some embodiments, the user interface module 214 is stored in the memory 237 of the computing device 200 and can be accessible and executable by the processor 235.

The user interface module 214 generates graphical data for displaying the metaverse as generated by the metaverse module 202. In some embodiments, the user interface includes options for the user to configure different aspects of the metaverse. For example, a user may specify friendships and other relationships in the metaverse. In some embodiments, the user interface includes options for specifying user preferences. For example, the user may find it distracting to receive audio from multiple users and, as a result, selects options for implementing cones of focus and virtual audio bubbles wherever they are applicable.

### Example Architecture 600

FIG. 6 is an example block diagram 600 of a spatial audio architecture. The spatial audio architecture includes a virtual private network 605 and edge clients 610. The virtual private network includes metaverse clients 615, a voice server 620, and a metaverse server 625.

The edge clients 610 are client devices that each display a metaverse to a user. Each edge client 610 is mapped to a metaverse client 615 that provides the graphical data for displaying the corresponding metaverse to each edge client 610.

The process for receiving audio in the spatial audio architecture includes edge clients 610 generating audio that is picked up by microphones associated with the edge clients 610. The edge clients 610 transmit audio packets that include the audio, timestamps, and digital entity IDs to the voice server 620. The voice server 620 filters the audio packets by amplitude, to ensure that the audio packets include detectible audio, and timestamps, to ensure that the audio packets are organized in the correct order. The voice server 620 transmits the filtered audio packets to the metaverse server 625. The metaverse server 625 filters the audio packets per avatar based on the spatial distance between a first avatar and the corresponding avatars. The metaverse server 625 transmits audio packets that are within the audio area to each corresponding metaverse client 615. The metaverse client 615 generates an audio-visual stream that is transmitted to the corresponding edge clients 610.

### Example Methods

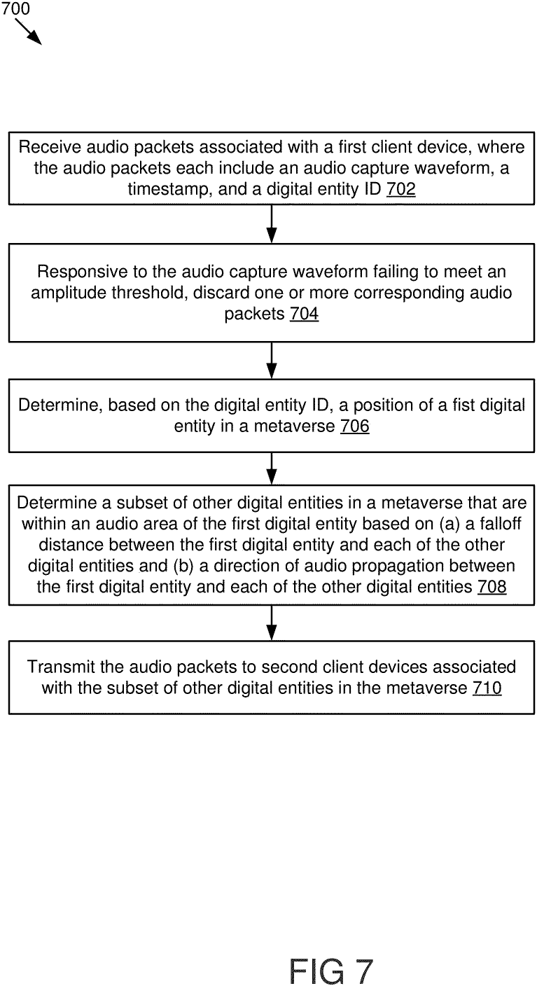

FIG. 7 is an example flow diagram of a method 700 to determine a subset of digital entities that are within an audio area of a first digital entity. In some embodiments, the method 700 is performed by the server 101 in FIG. 1. In some embodiments, the method 700 is performed in part by the server 101 and a client device 110 in FIG. 1. The method 700 may begin with block 702.

At block 702, audio packets associated with a first client device are received, where the audio packets each include an audio capture waveform, a timestamp, and an digital entity ID. Block 702 may be followed by block 704.

At block 704, responsive to the audio capture waveform failing to meet an amplitude threshold, one or more corresponding audio packets are discarded. Block 704 may be followed by block 706.

At block 706, a position of a first digital entity in a metaverse is determined based on the digital entity ID. The digital entity may be an avatar that corresponds to a human user or a virtual object of a digital twin that corresponds to a real-world object, such as a drone, submersible, robot, etc. Block 706 may be followed by block 708.

At block 708, a subset of other digital entities in a metaverse that are within an audio area of the first digital entity are determined based on (a) a falloff distance between the first digital entity and each of the other digital entities and (b) a direction of audio propagation between the first digital entity and each of the other digital entities. Block 708 may be followed by block 710.

At block 710, the audio packets are transmitted to second client devices associated with the subset of other digital entities in the metaverse.

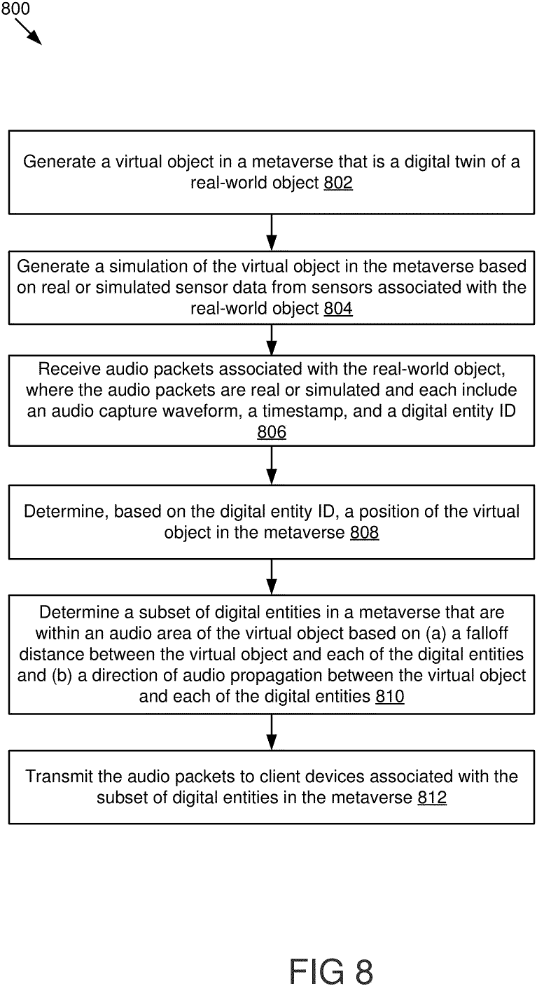

FIG. 8 is an example flow diagram of a method 800 to determine a subset of digital entities that are within an audio area of a digital twin. In some embodiments, the method 800 is performed by the server 101 in FIG. 1. In some embodiments, the method 800 is performed in part by the server 101 and a client device 110 in FIG. 1. The method 800 may begin with block 802.

At block 802, a virtual object is generated in a metaverse that is a digital twin of a real-world object. For example, the real-world object is a robot. Block 802 may be followed by block 804.

At 804, a simulation of the virtual object is generated in the metaverse based on real or simulated sensor data from sensors associated with the real-world object. For example, the sensors include audio sensors. In some embodiments, the sensors also include simulated sensors that are based on mathematical models. Block 804 may be followed by block 806.

At block 806, audio packets are received that are associated with the real-world object, where the audio packets are real or simulated and each include an audio capture waveform, a timestamp, and a digital entity ID. Block 806 may be followed by block 808.

At block 808, a position of the virtual object in the metaverse is determined based on the digital entity ID. Block 808 may be followed by block 810.

At block 810, a subset of digital entities in a metaverse are determined that are within an audio area of the virtual object based on (a) a falloff distance between the virtual object and each of the digital entities and (b) a direction of audio propagation between the virtual object and the digital entities. Block 810 may be followed by block 812.

At block 812, the audio packets are transmitted to client devices associated with the subset of digital entities in the metaverse.

The methods, blocks, and/or operations described herein can be performed in a different order than shown or described, and/or performed simultaneously (partially or completely) with other blocks or operations, where appropriate. Some blocks or operations can be performed for one portion of data and later performed again, e.g., for another portion of data. Not all of the described blocks and operations need be performed in various implementations. In some implementations, blocks and operations can be performed multiple times, in a different order, and/or at different times in the methods.

Various embodiments described herein include obtaining data from various sensors in a physical environment, analyzing such data, generating recommendations, and providing user interfaces. Data collection is performed only with specific user permission and in compliance with applicable regulations. The data are stored in compliance with applicable regulations, including anonymizing or otherwise modifying data to protect user privacy. Users are provided clear information about data collection, storage, and use, and are provided options to select the types of data that may be collected, stored, and utilized. Further, users control the devices where the data may be stored (e.g., client device only; client + server device; etc.) and where the data analysis is performed (e.g., client device only; client + server device; etc.). Data are utilized for the specific purposes as described herein. No data is shared with third parties without express user permission.

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may include a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may include information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A computer-implemented method comprising:
receiving audio packets associated with a first client device, wherein the audio packets each include an audio capture waveform, a timestamp, and a digital entity identification (ID);
determining, based on the digital entity ID, a position of a first digital entity in a metaverse;
determining a subset of other digital entities in a metaverse that are within an audio area of the first digital entity based on (a) a falloff distance between the first digital entity and each of the other digital entities and (b) a direction of audio propagation between the first digital entity and each of the other digital entities; and
transmitting the audio packets to second client devices associated with the subset of other digital entities in the metaverse.

2. The method of claim 1, wherein the falloff distance is a threshold distance and the subset of other digital entities are within the audio area if a distance between the first digital entity and the subset of other digital entities is less than the threshold distance.

3. The method of claim 1, wherein determining that the subset of other digital entities in the metaverse that are within the audio area of the first digital entity is further based on whether an object occludes a path between the first digital entity and the other digital entities.

4. The method of claim 1, wherein determining that the subset of other digital entities in the metaverse that are within the audio area of the first digital entity is further based on whether one or more objects in the metaverse cause wavelength specific absorption and reverberation of the audio packets.

5. The method of claim 1, wherein determining that the subset of other digital entities in the metaverse that are within the audio area of the first digital entity is further based on whether the first digital entity is a cone of focus that corresponds to a visual focus of attention of each of subset of other digital entities.

6. The method of claim 1, wherein determining that the subset of other digital entities in the metaverse that are within the audio area of the first digital entity is further based on whether the first digital entity and the subset of other digital entities are within a virtual audio bubble.

7. The method of claim 1, wherein:
the audio packets are first audio packets and further comprising mixing the audio packets with at least one selected from the group of second audio packets associated with the second client devices, environmental sounds in the metaverse, a music track, and combinations thereof to form an audio stream; and
the audio packets are transmitted as part of the audio stream.

8. The method of claim 1, wherein the first digital entity is a first avatar, the other digital entities are other avatars, and determining that the subset of other avatars in the metaverse that are within the audio area of the first avatar is further based determining a social affinity between the first avatar and the subset of other avatars.

9. The method of claim 1, further comprising:
responsive to the audio capture waveform failing to meet an amplitude threshold or determining that the one or more of the audio packets are out of order based on the timestamp, discarding one or more corresponding audio packets.

10. The method of claim 1, further comprising modifying an amplitude of the audio capture waveform based on one or more additional characteristics selected from the group of an environmental context, a technological context, a user actionable physical action, a user selection from a user interface, or combinations thereof.

11. The method of claim 1, wherein the first digital entity is a first avatar or a virtual object that corresponds to a digital twin of a real-world object, and the other digital entities are other avatars or other virtual world objects that correspond to digital twins of real-world objects.

12. A device comprising:
a processor; and
a memory coupled to the processor, with instructions stored thereon that, when executed by the processor, cause the processor to perform operations comprising:
generating a virtual object in a metaverse that is a digital twin of a real-world object, wherein the real-world object is a first client device;
generating a simulation of the virtual object in the metaverse based on real or simulated sensor data from sensors associated with the real-world object;
receiving audio packets associated with the real-world object, wherein the audio packets are real or simulated and each include an audio capture waveform, a timestamp, and a digital entity identification (ID);
determining, based on the digital entity ID, a position of the virtual object in the metaverse;
determining a subset of digital entities in a metaverse that are within an audio area of the virtual object based on (a) a falloff distance between the virtual object and each of the digital entities and (b) a direction of audio propagation between the virtual object and each of the digital entities; and
transmitting the audio packets to client devices associated with the subset of digital entities in the metaverse.

13. The device of claim 12, wherein the sensors associated with the real-world object are selected from the group of an audio sensor, an image sensor, a hydrophone, an ultrasound device, light detection and ranging (LiDAR), a laser altimeter, a navigation sensor, an infrared sensor, a motion detector, and combinations thereof.

14. The device of claim 12, wherein the falloff distance is a threshold distance and the subset of digital entities are within the audio area if a distance between the virtual object and the subset of digital entities is less than the threshold distance.

15. The device of claim 12, wherein determining that the subset of digital entities in the metaverse that are within the audio area of the virtual object is further based on whether an object occludes a path between the virtual object and the digital entities.

16. A non-transitory computer-readable medium with instructions stored thereon that, when executed by one or more computers, cause the one or more computers to perform operations, the operations comprising:
receiving audio packets associated with a first client device, wherein the audio packets each include an audio capture waveform, a timestamp, and a digital entity identification (ID);
responsive to the audio capture waveform failing to meet an amplitude threshold, discarding one or more corresponding audio packets;
determining, based on the digital entity ID, a position of a first digital entity in a metaverse;
determining a subset of other digital entities in a metaverse that are within an audio area of the first digital entity based on (a) a falloff distance between the first digital entity and each of the other digital entities and (b) a direction of audio propagation between the first digital entity and each of the other digital entities; and
transmitting the audio packets to second client devices associated with the subset of other digital entities in the metaverse.

17. The computer-readable medium of claim 16, wherein the falloff distance is a threshold distance and the subset of other digital entities are within the audio area if a distance between the first digital entity and the subset of other digital entities is less than the threshold distance.

18. The computer-readable medium of claim 16, wherein determining that the subset of other digital entities in the metaverse that are within the audio area of the first digital entity is further based on whether an object occludes a path between the first digital entity and the other digital entities.

19. The computer-readable medium of claim 16, wherein determining that the subset of other digital entities in the metaverse that are within the audio area of the first digital entity is further based on whether one or more objects in the metaverse cause wavelength specific absorption and reverberation of the audio packets.

20. The computer-readable medium of claim 16, wherein determining that the subset of other digital entities in the metaverse that are within the audio area of the first digital entity is further based on whether the first digital entity is a cone of focus that corresponds to a visual focus of attention of each of subset of other digital entities.
